(19) United States
(12) Patent Application Publication
(10) Pub. No.: US 2022/0288703 A1
(43) Pub. Date: Sep. 15, 2022

(54) SINGLE-LIP DRILL HAVING TWO LONGITUDINAL GROOVES IN THE RAKE FACE

(71) Applicant: botek Präzisionsbohrtechnik GmbH, Riederich (DE)

(72) Inventors: Peter Raber, Heusweiler (DE); Jürgen Deeg, Metzingen (DE); Patrick Kammerer, Nehren (DE); Dennis Köhler, Bempflingen (DE)

(73) Assignee: botek Präzisionsbohrtechnik GmbH, Riederich (DE)

(21) Appl. No.: 17/637,705

(22) PCT Filed: Jul. 28, 2020
(86) PCT No.: PCT/EP2020/071208

§ 371 Date: Feb. 23, 2022

(30) Foreign Application Priority Data
Aug. 23, 2019 (DE) 10 2019 122 686.4

(51) Int. Cl. B23B 51/06

(52) U.S. Cl. CPC B23B 51/066; B23B 2260/072

(57) ABSTRACT

The invention relates to single-lip drills in which two longitudinal grooves are formed in the rake face. They are arranged in the longitudinal direction of the tool, spaced apart from one another by a ridge and favor chip breaking.

### BACKGROUND

The invention relates to a single-lip deep hole drill. The terms essential for the disclosure of the invention are explained, inter alia, in conjunction with the description of the figures. Furthermore, at the end of the description of the figures, individual terms are explained in detail in the form of a glossary.

Various deep hole drills are known from the prior art which pursue different approaches in order to produce short chips. Short chips are a prerequisite for the problem-free and trouble-free removal of the chips through the bead of the drill head and the drill shank.

One approach to achieving this goal is described in DE 10 2010 051 248 A1. It proposes introducing a chip breaker in the form of a longitudinal groove approximately in the middle of the rake face and at the same time introducing at least one further longitudinal groove on the side face of the bead opposite the rake face. These longitudinal grooves are relatively narrow, that is, they each take up only about 15% of the width of the rake face or the opposite side of the flute.

A deep hole drill is known from JP-S-6234712 in which an elevation is formed in the rake face. This elevation is higher than the rake face. Recesses or longitudinal grooves can be formed to the right and left of this elevation. The essential feature is the elevation on the rake face, which is intended to cause the chips to break. Further single-lip drills are known from JP 2009 101460 A and WO 2018/219926 A1.

### SUMMARY OF THE INVENTION

The object of the invention is to provide a deep hole drill which is suitable for machining tough and/or long-chipping materials. In addition, it should be easy to manufacture and to regrind, and it should have a longer service life than conventional drilling tools with chip breakers. Moreover, the energy requirement during drilling is of course also an issue. A low drive power requirement reduces the thermal load on the cutting edge, which reduces tool wear and the stress on the workpiece being machined. This reduces direct and indirect costs.

According to the invention, this object is achieved in a deep-hole drill of the generic type in that two longitudinal grooves running parallel to the longitudinal axis of the deep-hole drill are machined into the rake face, between which grooves a ridge is formed which opens out into the cutting tip. A longitudinal groove according to the invention is a recess which is machined into the rake face and which runs essentially parallel to the longitudinal axis of the deep hole drill. The longitudinal grooves do not have to run exactly parallel to the longitudinal axis of the deep hole drill; deviations of up to 2° are possible; the advantages according to the invention are then still fully realized.

The parallel longitudinal grooves in the rake face do not protrude beyond the rake face, but instead are recesses if the rake face is viewed as a “zero level.” A bulge or an elevation beyond the rake face is not provided according to the invention. Placing longitudinal grooves according to the invention in a flat rake face according to the prior art by grinding, for example, is much easier, in terms of production technology, than providing an elevation. Conventional deep hole drills with a flat rake face can also be retrofitted subsequently by grinding in the longitudinal grooves according to the invention and can be reworked to form a deep hole drill according to the invention.

The longitudinal grooves according to the invention, which run parallel to one another, are relatively wide. This means that overall they take up at least 40% of the width of the rake face. All that remains of the original rake face is a ridge, which is formed between the two longitudinal grooves according to the invention, and one strip each between the secondary cutting edge and the outer longitudinal groove and between the inner longitudinal groove and the side wall of the bead. The tip or top of the ridge and the remaining strips are thus at the same level as the original rake face. Advantageous values for the width S₁ of the strip between the secondary cutting edge and the outer longitudinal groove can be found in claim 17.

The front ends of the longitudinal grooves according to the invention, the ridge and the remaining surfaces together with the flank face form the inner cutting edge and the outer cutting edge of the deep hole drill. The inner cutting edge and the outer cutting edge are therefore not straight, but rather comprise arcuate and/or polygonal portions. As a result, two chips are created (one is generated by the inner cutting edge, the other is generated by the outer cutting edge) which, immediately after they have been machined from the material by the cutting edges, flow in a sliding movement in the direction of the ridge. If the chips flow along the flank of the ridge in the direction of the tip of the ridge, the chips of both the inner cutting edge and the outer cutting edge are curled up and break after a short time. This means that both the chips generated by the inner cutting edge of the deep hole drill and by the outer cutting edge of the deep hole drill are rolled up and short-breaking.

Due to the ridge between the outer longitudinal groove and the inner longitudinal groove, the chip is divided into two chips and the width of the chips produced is—compared to a conventional deep hole drill with a flat rake face—halved as a first approximation. This also leads to smaller, more compact chips that can be better removed from the bore.

It has surprisingly been found in drilling tests that the two longitudinal grooves according to the invention have a positive effect on chip formation. In particular when machining tough materials, the chips become narrower and also shorter due to the inventive design of the cross section of the longitudinal grooves. This further improves the removal of chips from the bore produced and thus increases process reliability or allows an increase in the feed rate and thus a reduction in machining time and costs. In addition, tests have shown that with a favorable geometric configuration of the longitudinal grooves, the feed force drops by at least 10% with otherwise the same parameters. In individual tests, a reduction in the feed force of 15% was achieved. This reduction in the feed force leads to a better bore quality. In addition, the required drive power and the generation of heat in the region of the cutting are reduced. Reducing the generation of heat reduces wear on the cutting edge, which in turn increases the tool life.

Another advantage of the design of the rake face according to the invention is that the longitudinal grooves can be managed well in terms of production technology. As a rule, a profiled grinding wheel will be used and create the longitudinal grooves in one pass (by deep grinding). The drill head can then be coated with a wear protection layer.

If, after a certain period of operation, the inner and outer cutting edges of the deep hole drill have become blunt, the deep hole drill according to the invention can be sharpened again by regrinding the end face of the drill head (usually a so-called facet bevel is re-ground). It is not necessary to remove the coating or wear protection layer and then recoat the longitudinal grooves or the rake face after grinding. This means that the deep hole drill according to the invention can be reground by the customer. It is no longer necessary to return deep hole drills that have become blunt to the manufacturer. This is also a considerable advantage in terms of costs, availability and resource efficiency.

The ridge, which is somewhat inevitably produced between the two longitudinal grooves, always runs toward the tip of the deep hole drill. This means that when the tip of the deep hole drill moves in the radial direction outwardly or inwardly, the ridge is shifted accordingly between the two longitudinal grooves.

The longitudinal grooves are usually symmetrical with respect to the enclosing ridge. However, it is also possible for the longitudinal grooves to be geometrically similar, so that they have the same geometrical elements in cross section; however, the dimensions of these geometric elements differ. It is also possible for the inner longitudinal groove and the outer longitudinal groove to have a different profile.

The longitudinal grooves can have the shape of a first straight line and a tangentially adjoining curved line in a section plane running orthogonally to the axis of rotation of the deep hole drill. The first straight line and the rake face form an angle α and the curved line intersects the rake face at an angle β.

As a rule, the first straight line is located on the side of the longitudinal grooves opposite the ridge. In the case of the inner longitudinal groove, this means that the straight line begins in the region of the central axis and intersects the rake face there. In the region of the outer longitudinal groove, this means that the straight line begins in the region of the secondary cutting edge.

Then the curved line in cross section connects directly to the ridge 19; i.e., the curved lines form the ridge between the longitudinal grooves.

It has proven to be advantageous if the angle α between the straight line and the rake face is in a range between 30° and 10°; it is preferably in a range between 25° and 15°. It is particularly advantageous if the angle α has a value of 20°.

Regarding the angle β, ranges between 60° and 20°, preferably between 50° and 35°, have proven successful. In many applications, an angle θ of 45° is particularly advantageous.

The longitudinal grooves can have the shape of a segment of a circle, an isosceles triangle or a non-isosceles triangle in a sectional plane running orthogonally to the axis of rotation of the deep hole drill. Embodiments of these cross-sectional geometries of the longitudinal grooves are shown in the figures and are described further below.

The choice of cross-sectional shape depends, among other things, on the material to be machined. Another factor is the grinding wheels that are available. The grinding wheel required for grinding a longitudinal groove having a triangular cross section is easier to dress than a grinding wheel having a curved line in cross section. However, it is also possible with the aid of NC-controlled dressing machines and/or specially designed dressing tools to apply a curved profile to a grinding wheel.

All the geometries of the longitudinal grooves described in the description and claimed in the subclaims have proven to be very advantageous in practical tests.

In the deep hole drill according to the invention, the ridge opens out between the longitudinal grooves in the tip of the deep hole drill. It has proven to be advantageous if the distance between the tip and the secondary cutting edge is greater than 0.2×the diameter of the drilling tool. The distance should be less than 0.36×the diameter of the drilling tool. It has proven to be particularly advantageous in drilling tests if the distance between the tip and the secondary cutting edge is 0.25×the diameter of the drilling tool.

In order not to weaken the secondary cutting edge by the outer longitudinal groove according to the invention, it is further provided according to the invention that there is a distance of least 0.05 mm, preferably 0.1 mm, and particularly preferably 0.15 mm, between an edge of the outer longitudinal groove and the secondary cutting edge. This simplifies production, and the secondary cutting edge remains mechanically more resilient and breakaways on the secondary cutting edge are effectively prevented.

In a corresponding manner, it is provided that the ridge between the inner longitudinal groove and the outer longitudinal groove is not designed as a sharp edge, but rather has a width B>0.1 mm, preferably B>0.2 mm, and very preferably about 0.4 mm.

The ridge does not have to be sharp because it is not part of the main cutting edge, but rather forms the rake face. Rather, the flanks of the ridge are those parts of the longitudinal groove that cause the chips to curl and ultimately break.

The sum of a width of the inner longitudinal groove and a width of the outer longitudinal groove is greater than 0.2×the diameter of the deep hole drill. This means that the width of the two longitudinal grooves together makes up more than 40% of the width of the rake face.

The sum of a width of the inner longitudinal groove and a width of the outer longitudinal groove can also be greater than 0.4×the diameter of the deep hole drill. This means that the width of the two longitudinal grooves together makes up more than 80% of the width of the rake face.

In order to improve the tool life of the deep hole drill and improve the run-off of the chips on the surfaces of the longitudinal grooves according to the invention, at least the rake face or the longitudinal grooves and the wall of the bead are provided with a wear protection layer, in particular a hard material coating.

Further details, features and advantages of the subject matter of the invention result from the dependent claims and from the following description of the associated drawings, in which a plurality of embodiments of the invention are shown by way of example.

It is obvious that the invention can be applied to the most varied of shapes and geometries of longitudinal grooves. Therefore, the geometries of depressions shown in the figures do not limit the scope of protection of the claimed invention, but serve primarily for explanation and illustration.

### BRIEF DESCRIPTION OF THE DRAWINGS

In the drawings:

FIGS. 1 and 2 show a single-lip drill (prior art);

FIG. 3 shows a view from the front of the single-lip drill according to FIG. 1;

FIG. 4 shows a single-lip drill according to the invention in a top view;

FIG. 5 shows a single-lip drill according to the invention in a view from the front; and

FIGS. 6 to 8 show sections through different shapes of longitudinal grooves according to the invention.

### DETAILED DESCRIPTION OF THE EMBODIMENTS

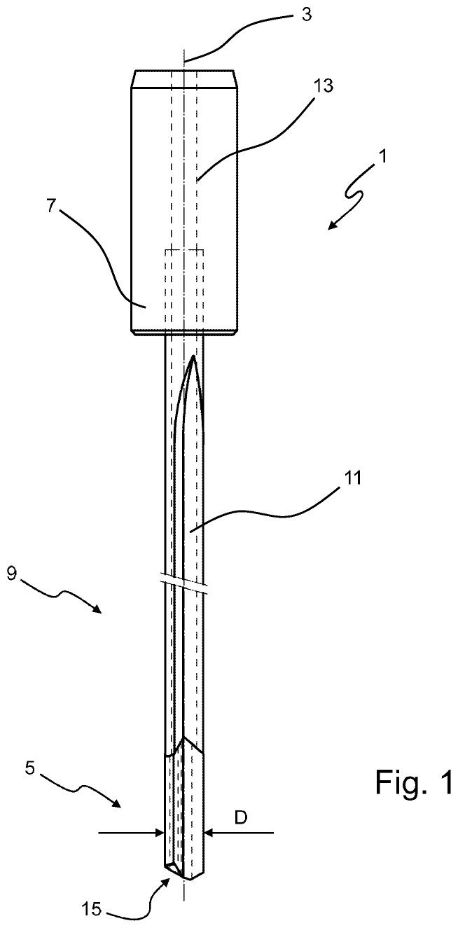

In all figures, the same reference signs are used for the same elements or components. FIG. 1 shows a single-lip drill 1. A central axis 3 is at the same time also the axis of rotation of the single-lip drill 1 or of the workpiece (not shown) when the drill is set in rotation during drilling.

A diameter of the single-lip drill 1 is denoted by D. The single-lip drill 1 is composed of three main components, specifically a drill head 5, a clamping sleeve 7 and a shank 9. This structure is known to a person skilled in the art and is therefore not explained in detail.

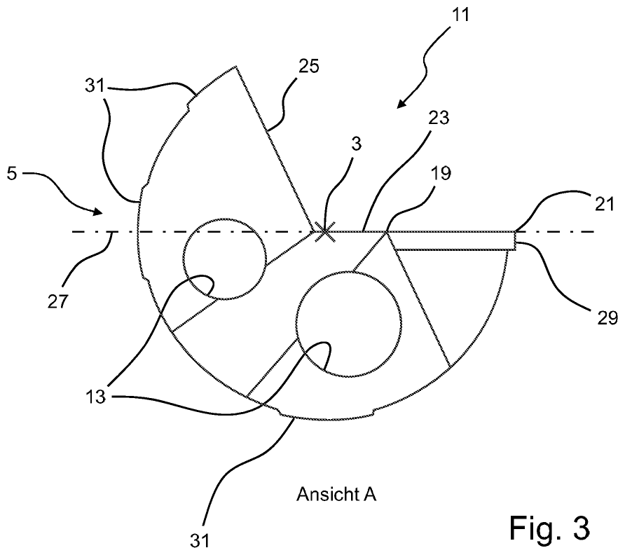

A bead 11 is provided in the shank 9 and the drill head 5. The bead 11 has a cross section approximately in the form of a segment of a circle (see FIG. 3) having an angle usually of approximately 90° to 130°. The bead 11 extends from the tip of the drill to in front of the clamping sleeve 7. Because of the bead 11, the drill head 5 and shank 9 have a cross section approximately in the shape of a segment of a circle with an angle of usually 230° to 270° (a supplementary angle to the angle of the bead 11).

A cooling channel 13 extends over the entire length of the single-lip drill 1. At one end of the clamping sleeve 7, coolant or a mixture of coolant and air is conveyed under pressure into the cooling channel 13. The coolant or the mixture of coolant and air exits back out from the cooling channel 13 at the opposite front end 15, the end face of the drilling tool. The coolant has a plurality of functions. On the one hand, it cools and lubricates the cutting edge and the guide pads. In addition, it conveys the chips produced during drilling out of the borehole via the bead 11.

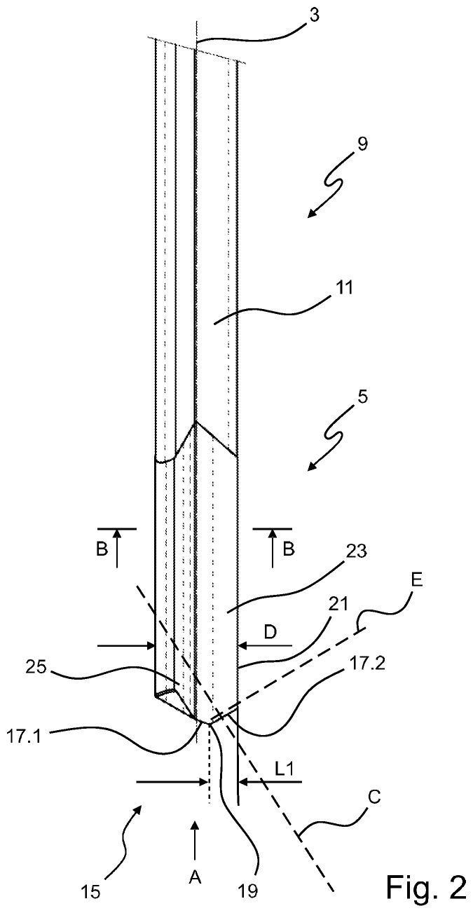

The front end 15 is shown slightly enlarged in FIG. 2. Elements of the drill head 5 are explained in more detail on the basis of this figure.

In single-lip drills 1, a cutting edge 17 usually consists of an inner cutting edge 17.1 and an outer cutting edge 17.2. A cutting tip has the reference character 19. As is usual with single-lip drills, the cutting tip 19 is arranged at a radial distance from the central axis 3. The inner cutting edge 17.1 extends from the central axis 3 to the cutting tip 19. The outer cutting edge 17.2 extends from the cutting tip 19 in the radial direction to the outer diameter D of the drill head 5 and terminates at a secondary cutting edge 21. There are also known bevels that are flattened at the tip. In this case, a theoretical cutting tip 19 is obtained by extending the inner cutting edge and the outer cutting edge to their theoretical intersection, which serves as a reference point for the longitudinal grooves. Grindings are also known which have the contour of a circular arc (radius grind). Then the forwardmost point of the drilling tool is the “cutting tip.”

A distance between the cutting tip 19 and the secondary cutting edge 21 is denoted by L₁ in FIG. 2. The bead 11 is delimited by a flat rake face 23 and a flat wall 25. The rake face 23 and the wall 25 form an angle of approximately 130°. In the embodiment shown, the rake face 23 extends through the central axis 3.

In FIG. 3, the central axis 3 is shown as “X”. The straight bead 11 is also clearly visible. It is defined by a rake face 23 and a wall 25. The rake face 23 and the wall 25 form an angle of approximately 130°. In the embodiment shown, the rake face 23 extends through the central axis 3. However, this does not have to be the case. The rake face 23 can run slightly below or slightly above the central axis 3. As a rule, the distance between the rake face 23 and the central axis 3 is less than 0.1 mm, preferably less than 0.05 mm. A rake face plane 27, indicated by a dot-dashed line, likewise extends through the central axis 3. The rake face plane 27 is a geometric definition which is not always and readily visible on the single-lip drill. The rake face plane 27 is defined in that it extends parallel to the rake face 23 and through the central axis 3. When the rake face 23 extends through the central axis 3, the rake face plane 27 and the rake face 23 coincide and the rake face plane 27 can be seen.

In FIG. 3, the inner cutting edge 17.1 can be seen as a line between the central axis 3 and the cutting tip 19. Correspondingly, the outer cutting edge 17.2 can be seen as a line between the cutting tip 19 and the secondary cutting edge 21. When viewed from the front, the inner cutting edge 17.1 and the outer cutting edge 17.2 coincide with the rake face 23. For the sake of clarity, reference signs 17.1 and 17.2 do not appear in FIG. 3.

In FIG. 3, two outlet openings of the cooling channel 13 are shown.

A plurality of guide pads 29 and 31 are formed on the drill head 5, distributed over the circumference. The guide pad 29 and the rake face 23 form the secondary cutting edge 21 where they intersect. This guide pad is referred to below as a circular grinding chamfer 29. The circular grinding chamfer 29 and the guide pads 31 have the task of guiding the drill head 5 in the bore.

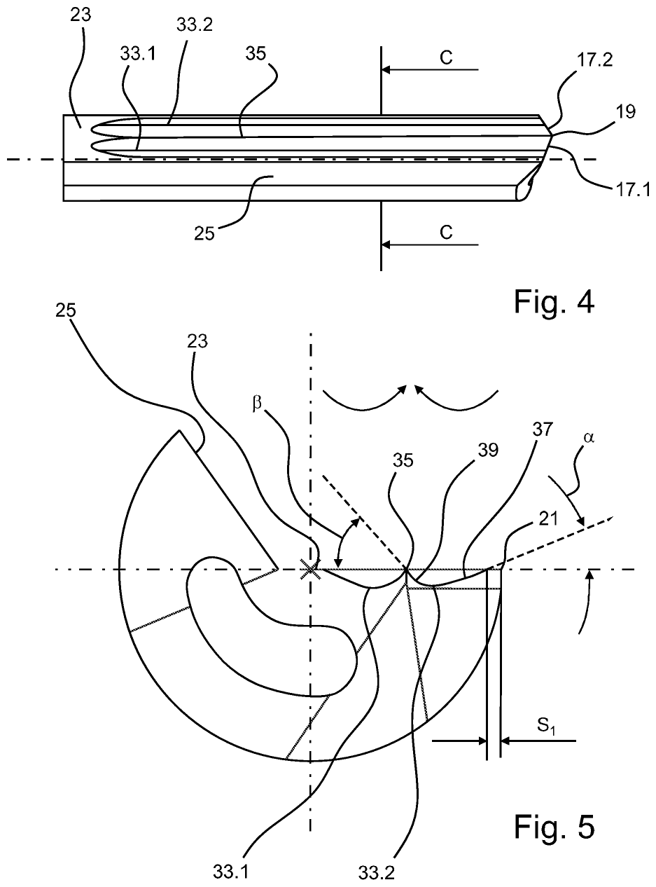

In FIGS. 4 to 7, embodiments of deep hole drills according to the invention are shown in a view from the front or as a partial section along the line C-C (see FIG. 4).

According to the invention, two longitudinal grooves 33, namely an inner longitudinal groove 33.1 and an outer longitudinal groove 33.2, are provided in the rake face 23. A ridge 35 is formed between the inner longitudinal groove 33.1 and the outer longitudinal groove 33.2. The highest point of the ridge 35 lies in the rake face 23 or slightly below it. In numbers: The ridge 35 is a maximum of 0.1 mm, but preferably less than 0.05 mm, below the rake face 23. The term “slightly below” is to be understood in such a way that when the longitudinal grooves 33.1, 33.2 are ground into the rake face 23 in the region of the ridge 35, a maximum of 0.1 mm is removed from the rake face 23. It can be seen from FIG. 4 that the longitudinal grooves 33.1 and 33.2 are made in sufficient length in the rake face 23 of the drill head 5, so that they are retained even after repeated resharpening by resetting the cutting edge 17.

As can be seen from FIGS. 4 and 5, there is a distance S₁ between the outer longitudinal groove 33.2 and the secondary cutting edge 21. This means that a narrow strip of the rake face 23 remains between the outer longitudinal groove 33.2 and the secondary cutting edge 21. As a result, the secondary cutting edge 21 is not weakened by the outer longitudinal groove 33.2. The strip with the width S₁ also has a positive effect on the load-bearing capacity and the service life of the cutting edge corner.

The mode of operation of the longitudinal grooves during chip formation and chip forming is explained with reference to FIG. 5. The shaping of the longitudinal grooves 33.1 and 33.2 according to the invention means that the chip, which is cut by the outer cutting edge 17.2, begins to flow on the straight line 37 in the direction of the ridge 35. As soon as it flows over the curved line 39 or the associated curved surface in the outer longitudinal groove 33.2 in the direction of the ridge 35, the chip is bent over and rolled up. This reshaping process leads to breaking of the chip generated by the outer cutting edge 17.2. In a corresponding manner, the same process also takes place in the region of the inner longitudinal groove 33.1.

The majority of the cutting process takes place in the radially outer region of the outer cutting edge 17.2 (where it is formed by the straight lines 37 and the flank face). There the chip is cut, it flows over the flat region of the outer longitudinal groove 33.2 represented by the straight line 37 in FIG. 5 in the direction of the ridge 35; i.e., radially inwardly. The curved surface of the outer longitudinal groove 33.2 represented by the curved line 39 rolls the flowing chip in and leads to its breaking off.

The two curved arrows (without reference symbols) in FIG. 5 illustrate this situation. It was possible to verify the processes described above in real bores by recording with a high-speed camera.

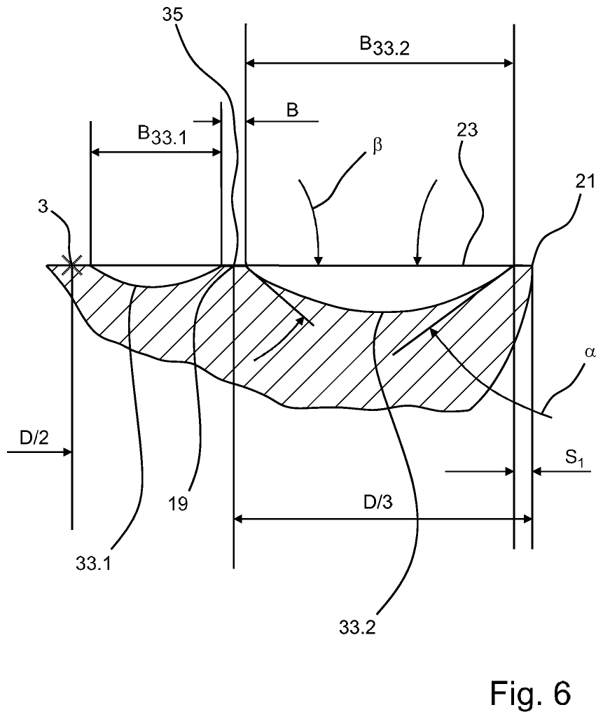

FIG. 6 shows a further embodiment of a deep hole drill according to the invention. FIG. 6 shows a partial section along the line C-C from FIG. 4. In this embodiment, the inner longitudinal groove 33.1 is designed in cross section as a continuously curved line, for example as a segment of a circle. The same applies to the outer longitudinal groove 33.2. In this embodiment, the inner longitudinal groove 33.1 and the outer longitudinal groove 33.2 are geometrically similar. This means that in cross section both have the shape of a curved line or a segment of a circle. However, a width B_{33.1} of the inner longitudinal groove 33.1 is smaller than a width B_{33.2} of the outer longitudinal groove 33.2. In this embodiment, the tip 19 or the ridge 35 is located at D/3 from the outer diameter of the drilling tool or the secondary cutting edge 21. Correspondingly, the ridge 35 is only D/6 away from the central axis 3 or axis of rotation of the drilling tool. It is also possible to move the tip 19 and the ridge 35 outwardly, so that the width B_{33.1} of the inner longitudinal groove 33.1 is greater than the width B_{33.2} of the outer longitudinal groove 33.2.

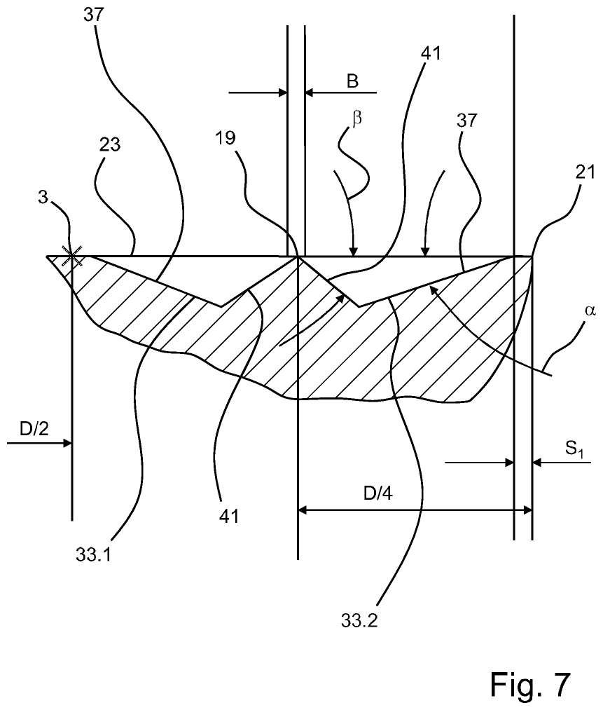

A further embodiment of longitudinal grooves according to the invention is shown in FIG. 7. In this embodiment, the longitudinal grooves 33 have the shape of a non-isosceles triangle in cross section. These triangles are formed from a first straight line 37 and a second straight line 41. The angle α is shown between the first straight line 37 and the rake face 23. The second straight lines 41 form the angle β with the rake face 23. The value ranges for the angles α and β are named in the claims and in the introduction to the description.

In this embodiment of the longitudinal grooves 33 according to the invention, the dressing of the grinding wheel is somewhat easier. In practice, a small radius will appear after a short time at the intersection of the first straight line 37 and the second straight line 41. This rounding is due to the wear of the grinding wheel at the lowest point of the longitudinal grooves 33.

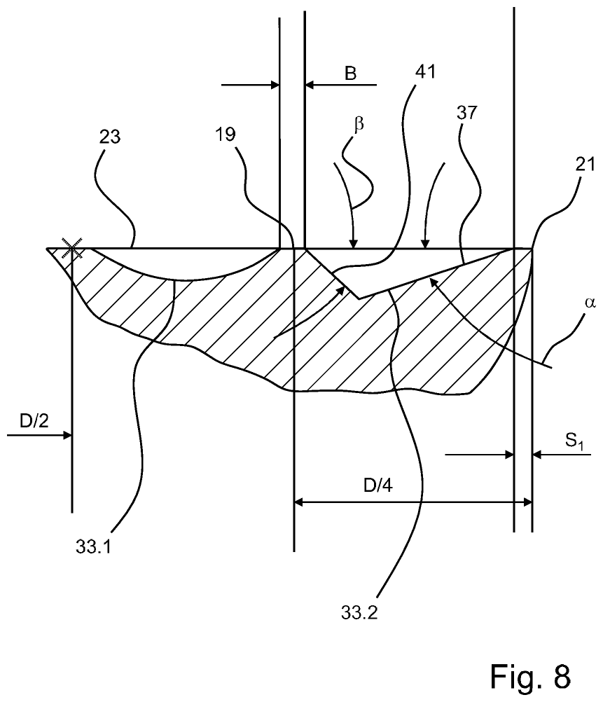

A further embodiment of longitudinal grooves 33.1 and 33.2 according to the invention is shown in FIG. 8. In this embodiment, the inner longitudinal groove has the shape of a segment of a circle in cross section, while the outer longitudinal groove 33.2 has the shape of a non-isosceles triangle which is formed by the straight lines 37 and 41.

It is of course also possible for the inner longitudinal groove 33.1 to have a triangular cross section, while the outer longitudinal groove 33.2 is designed as a circular arc-shaped longitudinal groove or as shown in the embodiment according to FIG. 5.

All embodiments have in common that a considerable part of the rake face is designed as a longitudinal groove, which is reflected in the fact that more than 40% (in some versions even 80% or more) of the rake face is removed by grinding in the longitudinal grooves 33. Only the ridge 35 remains, the width B of which is a maximum of 0.4 mm. At the outer edge, that is to say where the secondary cutting edge 21 is located, a narrow strip of the rake face 23 can remain, the width S₁ of which, however, is only a few tenths of a millimeter. The width can also depend on the diameter and be 0.1×D.

In the following, some terms are briefly explained and defined.

The overall shape of all cutting and non-cutting faces at the end face of the drill head is referred to as the nose grind. This also includes surfaces that do not directly adjoin the cutting edges, for example surfaces for directing the coolant flow or additional flank faces, to allow the drill to cut cleanly. The nose grind determines the shaping of the chips to a large extent and is matched to the material to be machined. The aims of the matching are, among other things, shaping chips that are as favorable as possible, a high machining speed, the longest possible service life of the drill, and compliance with the required quality characteristics of the bore such as diameter, surface or straightness (center deviation).

To increase the service life, the drill head can be provided with a coating as wear protection, mostly from the group consisting of metal nitrides or metal oxides; the coating can also be provided in a plurality of alternating layers. The thickness is usually approx. 0.0005 to 0.010 mm. The coating is carried out by means of chemical or physical vacuum coating processes. The coating can be provided on the circumference of the drill head, on the flank faces or on the rake faces, and in some cases the entire drill head can also be coated.

Single-lip drills are single-edged deep hole drills. Single-lip drills are long and slender and have a central axis. The rake face thereof is flat; hence they are also referred to as “straight grooved” tools. They are used to create bores that have a large length to diameter ratio. They are mainly used in industrial metal working, such as in the production of engine components, in particular in the production of common rails or gear shafts.

Single-lip drills are usually used in a diameter range of approx. 0.5 to 50 mm. Bores having a length of up to about 6,000 mm are possible.

The length to diameter ratio (L/D) of the bore is usually in a range from approx. 10 to over 100; however, it can also be approx. 5 and up to about 250.

Single-lip drills are characterized by the fact that a high-quality bore can be produced in one stroke. They can be used in machine tools such as lathes, machining centers or special deep drilling machines.

The machining process is performed by means of a movement of the drill relative to the workpiece in the direction of rotation about a common central axis, and a relative movement of the drill toward the workpiece in the direction of the common central axis (feed movement). The rotational movement can be caused by means of the drill and/or the workpiece. The same applies to the feed movement.

The flank face is the surface at the tip of the drill head that is opposite the machined workpiece surface.

Guide pads are arranged on the circumference of the drill head to support the cutting forces in the drilled bore which arise during cutting. Guide pads are cylinder segments having the diameter of the drill head; they abut the wall of the bore during the drilling process. Radially recessed segments having a smaller diameter are arranged on the drill head, between the guide pads in the circumferential direction, such that a gap is formed between the bore wall and the drill head. The gap is used to collect coolant for cooling and lubricating the guide pads.

There are different arrangements of guide pads; the design depends on the material to be machined. The first guide pad, which adjoins the rake face counter to the direction of rotation of the drill, is referred to as the circular grinding chamfer.

Coolant or a mixture of coolant and air (minimum quantity lubrication) is conveyed through the cooling channel to lubricate and cool the drill head and the guide pads as well as to carry the chips away to the tip of the drill head. Coolant is supplied under pressure to the rear end, passes through the cooling channel and exits at the drill head. The pressure depends on the diameter and length of the drill.

By adapting the pressure of the coolant, single-lip drills can drill very small and very deep bores in one go.

During the drilling process, the deviation [mm] of the actual drilling central axis from the theoretical drilling central axis is regarded as the center deviation. The center deviation is an aspect of the bore quality. The aim is to achieve the smallest possible center deviation. In the ideal case, there is no center deviation at all.

Regrinding can allow a single-lip drill that has become blunt to be usable again. Regrinding means readjusting/grinding the worn part of the drill head mostly on the end face until all worn regions (in particular of the rake face and flank face) have been removed and a new, sharp cutting edge has been formed. The nose grind then reverts to its original shape.

The line of contact (edge) between the rake face and the circular grinding chamfer is referred to as the secondary cutting edge. The point of intersection between the outer cutting edge and the secondary cutting edge is referred to as the cutting corner.

The drill head has a cutting edge, which can be divided into a plurality of cutting edge portions and a plurality of stages. The cutting edge is the region that is involved in the machining. The cutting edge is the line of intersection of the rake face and the flank face. The cutting edge is usually divided into a plurality of straight partial cutting edges.

The rake face is the region on which the chip is discharged; it can also consist of a plurality of partial surfaces.

A chip-forming device is a recess machined into the rake face, extending parallel to the cutting edge and directly adjoining the cutting edge. In other words: There is no rake face between the cutting edge and the chip-forming device.

A chip divider constitutes a “break” in the outer cutting edge, which reduces the width of the chips.

1. A single-lip drill comprising a drill head, the drill head having an axis of rotation, a drilling diameter and a cutting edge, a rake face being assigned to the cutting edge, longitudinal grooves running parallel to each other being provided in the rake face, and a ridge being provided between the inner longitudinal groove and the outer longitudinal groove, characterized in that the ridge opens out into the cutting tip.

2. (canceled)

3. (canceled)

4. The single-lip drill according to claim 12 or 3, characterized in that the longitudinal grooves are arranged symmetrically or geometrically similar in cross section to the ridge.

5. The single-lip drill according to claim 1, characterized in that the longitudinal grooves have the shape of a first straight line and a tangentially adjoining curved line in a cutting plane running orthogonally to the axis of rotation of the deep hole drill, that the first straight line and the rake face form an angle (α), and that the curved line intersects the rake face at an angle (β).

6. The single-lip drill according to claim 1, characterized in that the longitudinal grooves have the shape of a first straight line and an adjoining second straight line in a sectional plane running orthogonally to the axis of rotation of the deep hole drill, that the first straight line and the rake face form an angle (α), and that the second straight line and the rake face form an angle (β).

7. The single-lip drill according to claim 5, characterized in that the angle (α) is less than or equal to 30° and/or that the angle (α) is greater than or equal to 10°.

8. The single-lip drill according to claim 5, characterized in that the angle (α) is less than or equal to 25° and/or that the angle (α) is greater than or equal to 15°.

9. The single-lip drill according to claim 5, characterized in that the angle (α) is equal to 20°.

10. The single-lip drill according to claim 5, characterized in that and the angle (β) is less than or equal to 60° and/or that the angle (β) is greater than or equal to 20°.

11. The single-lip drill according to claim 5, characterized in that the angle (β) is less than or equal to 50° and/or that the angle (β) is greater than or equal to 35°.

12. The single-lip drill according to claim 5, characterized in that the angle (β) is equal to 45°.

13. The single-lip drill according to claim 1, characterized in that the longitudinal grooves have the shape of a segment of a circle, an isosceles triangle or a non-isosceles triangle in a sectional plane running orthogonally to the axis of rotation of the deep hole drill.

14. The single-lip drill according to claim 1, characterized in that a distance (L₁) of the cutting tip and the ridge from the secondary cutting edge is greater than 0.2 times the diameter (D). (L₁>0.2×D)

15. The single-lip drill according to claim 1, characterized in that a distance (L₁) of the cutting tip and the ridge from the secondary cutting edge is less than 0.36 times the diameter (D). (L₁<0.36×D)

16. The single-lip drill according to claim 1, characterized in that a distance (L₁) of the cutting tip and the ridge from the secondary cutting edge is 0.25 times the diameter (D).

17. The single-lip drill according to claim 1, characterized in that a distance (S₁) between an edge of the outer longitudinal groove and the secondary cutting edge is at least 0.05 mm.

18. The single-lip drill according to claim 1, characterized in that the ridge has a width (B) at its highest point, and that the width (B) is a maximum of 0.4 mm.

19. The single-lip drill according to claim 1, characterized in that the sum of a width (B_{33.1}) of the inner longitudinal groove and a width (B_{33.2}) of the outer longitudinal groove is greater than 0.4×the diameter (D) of the deep hole drill.

20. The single-lip drill according to claim 1, characterized in that the drill head is at least partially provided with a hard material coating.
